(19) United States
(12) Patent Application Publication
(10) Pub. No.: US 2007/0182235 A1
(43) Pub. Date: Aug. 9, 2007

(54) Restraint plate for humans in vehicles

(76) Inventors: Antonio Celso Fonseca De Arruda, Campinas (BR); Peixoto Bueno Camargo, Goias (BR)

Correspondence Address: TRASK BRITT, P.O. BOX 2550, SALT LAKE CITY, UT, 84110, US

(21) Appl. No.: 10/589,412

(22) PCT Filed: Oct. 7, 2004
(86) PCT No.: PCT/BR04/00195

§ 371 Date: Mar. 30, 2007

(30) Foreign Application Priority Data
Apr. 15, 2004 (BR) PI 0401591-6

(51) Int. Cl. B60R 22/00

(52) U.S. Cl. 297/468

(57) ABSTRACT

Restraint plate for humans in vehicles, comprised of belts (1) that surround the shoulders and the waist of a child and which are sewn for maximum safety. The device is also comprised of a plate (2) for cervical protection, which should be attached to the car seat by the conventional seat belt that comes in the car and another belt (18) designed to secure the whole device to the car seat.

### FIELD OF INVENTION

This invention is a RESTRAINT PLATE FOR HUMANS IN VEHICLES, comprised of a fully anatomical RESTRAINT PLATE with several openings for the straps which will serve to restrain the user. More specifically, the Restraint Plate of this invention will be attached to the car seat. This low-weight device is easy to install, and can be handled by anybody. Even more specifically, the plate will be attached to the car by the existing seat belt.

### PRINCIPLE OF THE INVENTION

Lately, many countries have passed laws requiring the use of retention devices for children. The criteria under consideration are weight, size or height or even age brackets. From this standpoint, there have been many inventions, which aim to relate to this normalization. They aim to provide a means to comply with the legislation, to provide low-cost products which are safer and which, at the same time, will mean more comfort both for the direct user—the children—and for the indirect user, the adults who use the cars to which they are attached.

As an example of an attempt to improve in the safety and comfort criteria, we have U.S. Pat. No. 6,572,189, in which Lee M. Blaymore raises the problem of chairs which are attached to the car seat and which have raised side panels, which serve as arm rests for the child. As it turns out, these raised sides present an obstacle for removing the child as they block the exit path. To solve this problem, a platform attached by the car seat belts was created. This platform has a horizontal and a vertical plate where the child seat would be placed. This device would allow the chair to rotate towards the exit door, thereby making it possible to access the child and to remove him/her from the car from a frontal position. However, in this case, the chair will remain attached to the car seat on a permanent basis and will therefore, occupy considerable space in the vehicle, which means a loss of usable room. Moreover, those chairs with armrests impair the child's mobility and do not allow heat to be dissipated easily.

In U.S. Pat. No. 6,679,550 (Goor et al), a child safety seat that can be attached to the front seat of the car is demonstrated. This document states that data from the United States Government show that several children sustained serious injuries and some have even died because of the impact with the back rest of the front seat, especially when there is someone sitting there at the moment of the accident. However, this chair requires the adult to remove it and place it somewhere else in the car, anytime someone needs the space to sit. The whole procedure can be rather inconvenient. Moreover, this invention requires the existence of an air bag for the seat to which it is attached and can not be placed in cars that do not come with this safety device. An alternative would be to fit the child seat with its own air bag and that would be counterproductive as the final cost would be considerably increased.

U.S. Pat. No. 4,848,793, USA Fred Huspen and Lara L. Thomas; U.S. Pat. No. 12,992,097, Canada; patent No. 204,542,88, Japan and patent No. 88307607.7, Europe, all describe safety devices for children. They contain a plate which is surrounded by two sets of straps distributed in such a way that, in the event of a collision or a sudden need for braking, could seriously harm the user, as described below: the horizontal strap is located over the abdomen of the child and that could injure the internal organs in case of an accident or even if the driver has to brake suddenly; there is no guarantee that the straps placed vertically over the shoulders would remain in their correct position, because children are naturally restless and are always fidgeting. With regards to the plate, the size will cause it to move. Many variables are at play, and depending on the seriousness of the accident or the speed of the vehicle when the brakes were applied, the movement of the child will cause the plate to change positions. It may even result in the plate coming to a longitudinal position between the child and the car seat. Therefore, the whiplash effect on the child's body can result in serious injuries. This issue is brought up because the problem and consequent injury will be compounded because the fixation system for the plate consists only of the conventional sub-abdominal seat belt. There is no auxiliary retention or fixation system, which will cause to plate to become really stabilized. With regards to the anatomical aspect of the plate, it is possible to verify that it does not offer comfort to the user, as it is not molded. Another question that must be considered is the effect of whiplash on the neck. It is known that this causes deceleration of the brain, avoided only if the plate design provides for some angulation, which we could not see in these plates. Since there is no adequate system for adjusting the plate by age brackets and child size, since we know that there are regulations that deal with different age groups, and since the restraint devices must follow the current norms and regulations, it is impossible to have a single product which would fit all customers, or one without an adjustment mechanism that would allow it to be adjusted to the child's growth.

Aiming to solve the problem caused by multiple users for the same car seat, U.S. Pat. No. 6,676,213, Timothy S. Dlugos, claims a child's safety seat which has removable seats of several sizes and which can accommodate people of various sizes and weight. On the other hand, in spite of enabling different people to use it, this chair continues to present the same inconvenience of other chairs, since the removable parts will continue to occupy considerable space within the vehicle. In addition to that, there is the question of having to select which seat would be more comfortable for which person. We find it worthwhile pointing out that this device does not use the seat belts that already come with the car. They are attached by their own straps. This could possible result in an incorrect positioning of this device by the user, with the consequent loss in safety.

Since the strap distribution system has a clasp that allows for different adjustment points for effective restraint, the straps that are used for restraint will always remain in place, relative to the child's body, that is, fastened and adjusted to the shoulders and pelvis. According to the guidelines issued by orthopedists, these are the places where restraint should be applied. Even if the child moves about, the straps will remain securely fastened to the correct places.

Therefore, it would be interesting to develop a new concept in safety devices for humans in vehicles which would adhere to the safety norms and legislation and which would, at the same time, represent a seat which could be used by people of different sizes and weight, would allow for the dissipation of heat, would not constrain arm and leg movement, which would be attached to the seat by seat belts that come in the car and whose production costs would be relatively low.

### BRIEF DESCRIPTION OF THE DRAWINGS

FIG. 1 represents a frontal view of the RESTRAINT PLATE, which will be used by human in vehicles.

FIG. 2 has a view of the back of the RESTRAINT PLATE FOR HUMANS IN VEHICLES. One can see the terminal which must be fastened to the body of the car and the belt that will fasten the cervical protection plate to the seat back, as well as the belt that gathers all the other belts on the back.

On FIG. 3 one can see another frontal view of the RESTRAINT PLATE FOR HUMANS IN VEHICLES. The figure shows the padded protection with the slits and guides for the straps and for the conventional seat belt straps.

FIG. 4 is a side view of the RESTRAINT PLATE FOR HUMANS IN VEHICLES, where the different in thickness in the lower part is shown. This allows for the human to remain in a position that would decrease the effect of backlash injury to the neck.

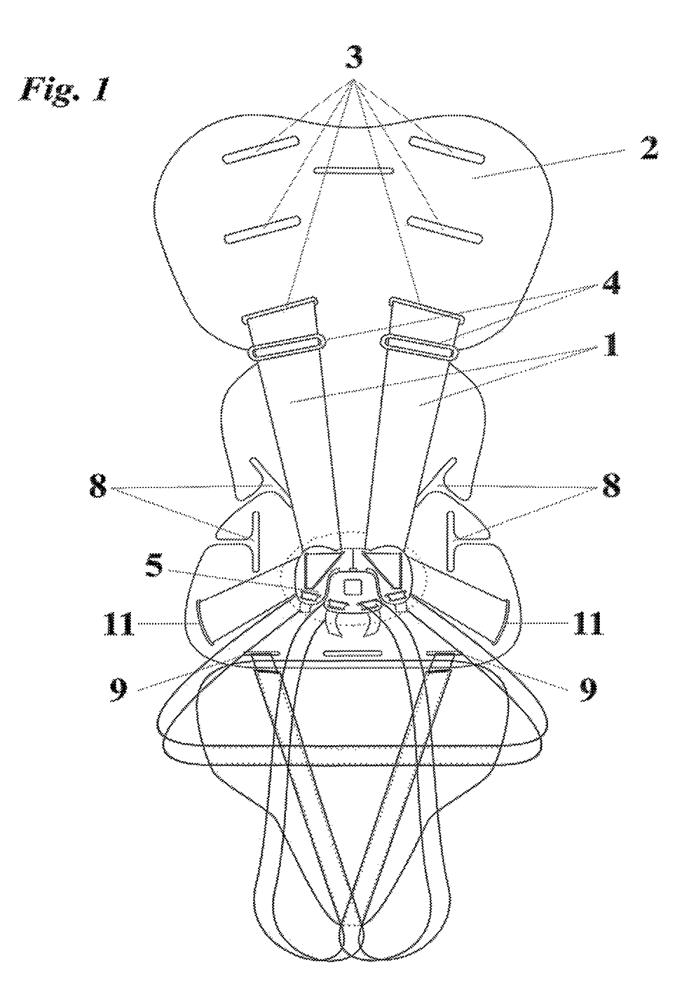

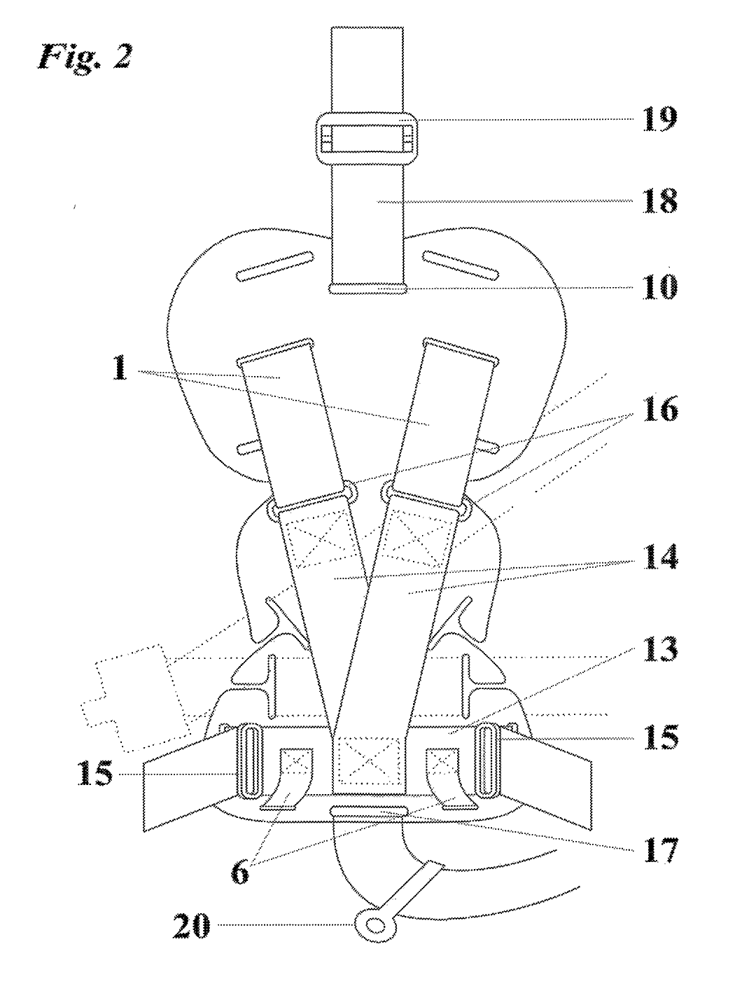

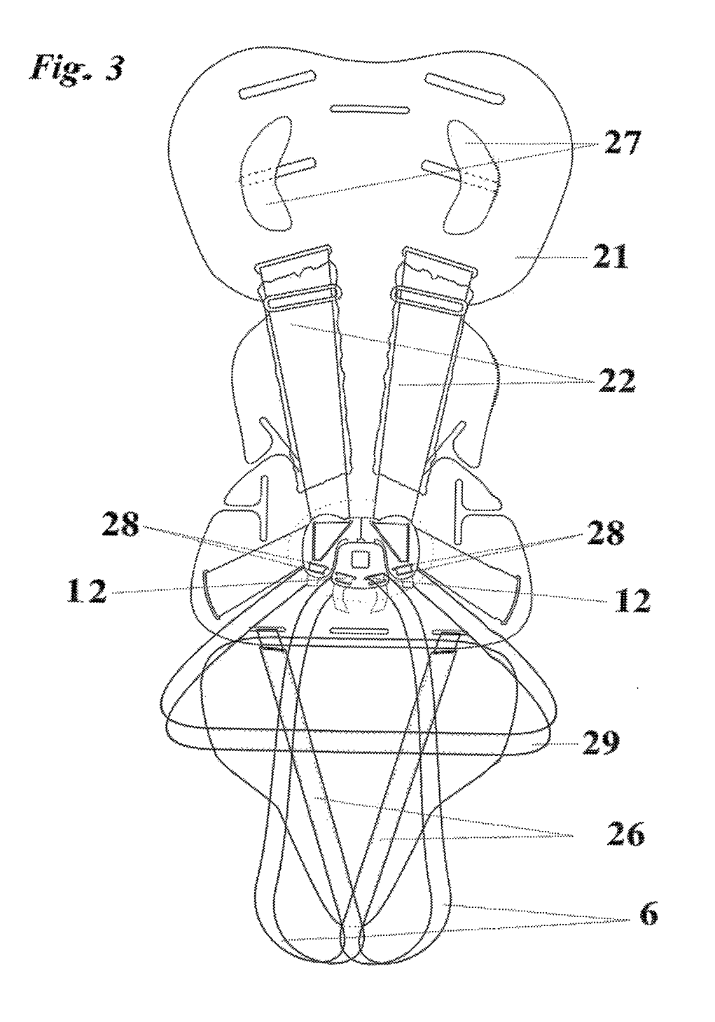

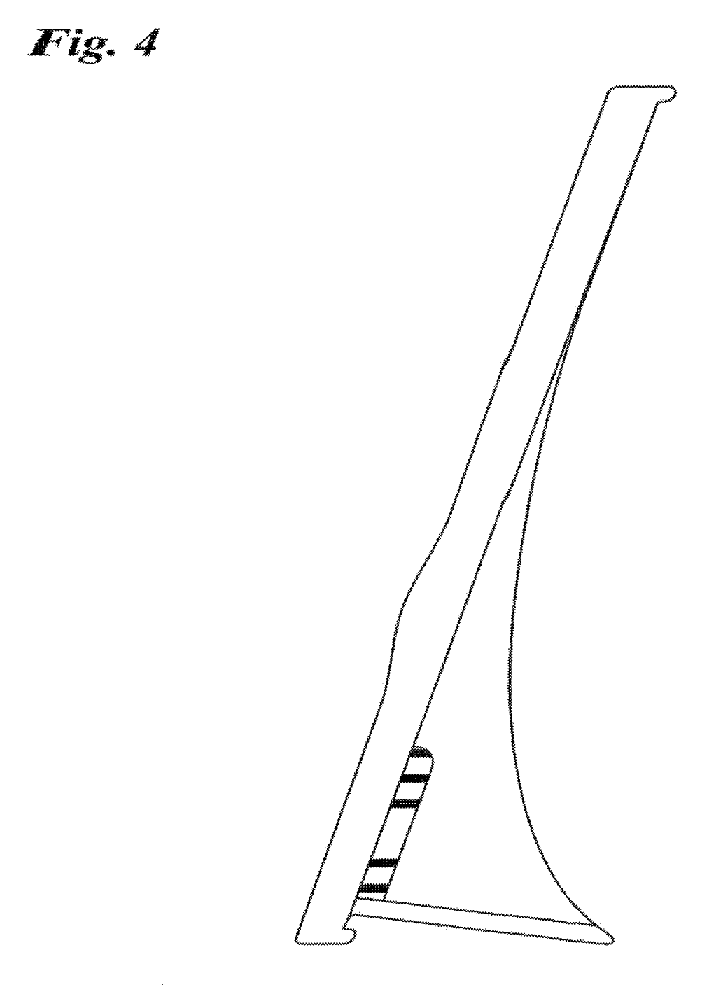

### BRIEF DESCRIPTION OF THE INVENTION

This invention is a RESTRAINT PLATE FOR HUMANS IN VEHICLES, which would replace the current safety seats for children. The Restraint Plate is light and fully anatomical and can be easily attached to the car seat through its own safety strap system. In addition to being easy to attach, it allows for the dissipation of heat, and gives the child freedom of movement. This plate represents an improvement over current devices, as it does not prevent other people, of different height and weight, from using the car seat.

That is, when installed, the plate whose patent is being requested will not take up useful space so hat other users can occupy the place where it was installed. Anyone will be able to seat comfortably where the plate was installed. Removing it for adults becomes then unnecessary. This is not the case when a conventional safety seat in installed in a car.

This plate can be used by people of different age brackets: from 32-month old children to 13 year olds. It can also be used by physically challenged people, especially those who have motor coordination problems or neurological disorders. The plate won't require replacement as all that is necessary is to adjust for the height of the person using it. The same can not be said for the current safety chairs since they need to be replaced as their users grow.

Since the plate is perforated and does not have side panels, it will not cause the user to feel undue heat, one of the most significant drawbacks of the current devices, which were mostly designed to be used in cold-climate places, rather than in a place where warm weather prevails. In addition to that, this invention allows the user to have greater freedom of movement. Because of its configuration, it is also easy to remove the child from the seat, since there are no side panels to block the way.

The fact that it is an easily installed, lightweight device represents another significant advantage over the currently available seats, as the latter are usually heavy and cumbersome and difficult to position properly. This increases the possibilities of a mistake in the installation, which could cause accidents or, at the very least, represent a breach in the security they offer their users.

Since the plate is a small device, with few parts, it will be very cost effective and we estimate that it will retail for approximately 25% of the price of the existing chairs.

### DETAILED DESCRIPTION OF THE INVENTION

This invention is described below through the presentation of the physical features of the product we are requesting a patent for, including but not limited to the described application:

The belts (1) that surround the shoulders are attached by flattened rings (16) to the straps which are located on the back of the cervical protection plate (2). They come out from the front of the cervical protection plate (2) and pass separately to the back of the cervical protection plate (2) through the slits (3) and surround the shoulders, where the belts (1) come down to around the height of the waist of the human being. At this point they are close to each other, but they pass separately through two latches which make up the locking system for the 3-point belt lock (5). When they are waist high, the straps (1) go towards the front of the cervical protection plate (2), passing through slits (11) where the ends of the straps (1) will be fastened to the other strap (13) through a set of flat rings (15) which will work as a self-locking system. Both straps (6) will be firmly sewed to this strap (13) separately, on the front of the cervical protection plate (2) and will come out from the front of the cervical protection plate (2) pass through the slits (9) and go towards the lower part of the back of the cervical protection plate (2), and thus come out between the child's legs. The straps (6) will then go up to the child's waist where they will pass, separately through two regulating buckles (12) which will be sewed to the lower end of the 3-point attachment system (5). The cervical protection plate (2) will have six slits (3) that serve to adjust the straps (1) to the child's height. Each strap (1) will also have another adjustment device (4) for fine tuning the height adjustment. The cervical protection plate (2) will have six slits (8) for the conventional seat belt straps. They can be threaded from left to right or vice-versa. The cervical protection plate (2) has a slit (10) in the upper part and another slit (17) in the lower part. They will be used to pass the strap (18) to the back of the cervical protection plate (2) between the cervical protection plate (2) and the padded cover (21) that will surround the cervical protection plate (2) next to the car seat. The end of the strap will have a terminal (19) with a self-locking system for the straps (18). In the place where the strap (18) passes through the lower border of the car seat back, there will be a terminal (20) with a hole. Use a screw to attach it to the body of the car, next to the place where the conventional seat belt is attached. The cervical protection plate (2) is molded in such a way as to be fully anatomical and comfortable to a child's back. It will also be fitted with a padded cover (21) that will provide additional protection and comfort. At shoulder height, the straps (1) will be padded (22) and this padding will help absorb any impact. The front part of the cervical protection plate (2) has a support that was specially designed so that the plate (2) rests at a slight angle towards the back. That feature will contribute to decrease backlash injury to the neck. The lower part of the padded cover (21) is designed for the child to sit on. In the padded cover (21) there are two internal guides (26) that will serve as openings for the two straps (6) to go through (26), so that they come from the front of the child, around the kidneys, go towards the back and come out together between the legs where they will again be joined by the two adjustment buckles (12). There are six slits (3) in the cervical protection plate (2). They are there to allow the side head rests to be fastened (27). These will come equipped with a cricket self-locking system on the lower extremity. Such a system will allow for the side head rest to be firmly fastened (27) to the slits (3), so as to provide a perfect fit for the human user. The purpose of the side rests (27) will be to decrease the impact in the case of lateral collisions, thus reducing the problems caused by the space/weight variables. On one side of the 3-point belt system (5) there are two adjustable openings (28) for the strap (29) that goes under the user's legs. They can be threaded from left to right or vice-versa and pass through two other adjustable openings (28) located on the other side of the 3-point system (5). A strap (29) is used to adjust the 3-point system (5) so that it is placed in the correct height, over the user's abdomen and also to keep the straps (11) in position in relation to the user's pelvis.

The materials used in the Restraint Plate for humans are listed but are not limited to plastics and elastometers currently in use and which have the required size and resistance for use in this invention. Other materials, such as metals, can also be used (i.e. porous aluminum, aluminum foam—or compressed aluminum—and other composite materials).

This invention was tested in a Vectra, a passenger car made by GMB (General Motors Brazil). Impact tests were carried out against a truck bumper and a rigid barrier, in strict accordance with global crash-test standards.

In the first test, the vehicle speed was 50 Km/h, and the impact represented a 11 G deceleration. During the second test, although the speed used was the same, at the time of the collision, deceleration was measured at 35 G. In both tests, the results demonstrated that the performance of the RESTRAINT PLATE FOR HUMANS was better than the specifications set forth by European, American and Brazilian norms, in which deceleration tests of only 20 G were required.

That is, when using an instrumented dummy, representative of a 6-year old child weighing 28 Kg, both the movement of the plate, in relation to the car seat and of the dummy in relation to the plate, the head movement and the backlash, were extremely satisfactory, as the final figure was around 480 mm, that is, below the 540 mm required by national and international norms.

The above description of this invention served to illustrate its use. However, this description is not intended to limit the uses the invention might have, to those revealed here. Consequently, changes that prove to be compatible to what has been revealed above, as well as the skill or knowledge of the relevant technique, fall within the scope of this invention.

The intention of the above description is to better illustrate the known uses for this intervention and to allow the technicians who work in this field to use this invention in this manner or in other manners, and incorporate any changes that might be needed in view of specific applications or uses this invention might be put to. The overall aim is that this invention includes all the changes and variations that might fall within the scope of this report and the attached claims.

1. “RESTRAINT PLATE FOR HUMANS IN VEHICLES”, characterized by the fact that it is comprised of two belts (1) that surround the shoulders and pass through two latches that form the 3-point locking system (5). They then return to the anterior end, at the height of the waist, where these straps go through openings (11) in the fully anatomical and padded cervical protection plate (2). The two straps are joined behind the plate and the end of each strap will be fastened to another strap which has a two-ring system (15) which will serve as controlling and adjusting devices for the strap (13) that remains on the back of the cervical protection plate (2). Two straps (6) go towards the back of the plate and will pass between the legs of the person being restrained. The same straps will continue towards the waist and will be fastened in the locking system (5) where the cervical protection plate (2) has slits (8) through which the conventional seat belt can pass to secure the back of the safety seat to the car seat, thus allowing for the car seat retractor system to work, should an accident happen. Another strap (18) will surround the cervical protection plate (2) and fasten it to the car seat. This same strap (18) will have a terminal (20), which must be screwed to the car body, next to the point where the conventional seat belt is attached.

2. “RESTRAINT PLATE FOR HUMANS IN VEHICLES”, according to claim 1, characterized by the fact that it is intended for use in automotive vehicles.

3. “RESTRAINT PLATE FOR HUMANS IN VEHICLES”, according to claim 2, characterized by the fact that it is to be used in cars, airplanes, buses, ships and vehicles destined to domestic use.

4. “RESTRAINT PLATE FOR HUMANS IN VEHICLES”, according to claim 1, characterized by the fact that it is to be used by humans ranging in age from 32 months to 12 years of age.

5. “RESTRAINT PLATE FOR HUMANS IN VEHICLES”, according to claim 4, characterized by the fact that it is to be used by growth impaired people as well as those who have problems maintaining their balance.

6. “RESTRAINT PLATE FOR HUMANS IN VEHICLES”, according to claim 4, characterized by domestic use by impaired people who have problems maintaining their balance.

7. “RESTRAINT PLATE FOR HUMANS IN VEHICLES”, according to claim 1, characterizing the fact that it is intended for use by people with physical impairments, of any age.
